(19) United States
(12) Patent Application Publication
(10) Pub. No.: US 2012/0093563 A1
(43) Pub. Date: Apr. 19, 2012

(54) DECKING COATING COMPOSITION APPLICATOR

(75) Inventors: Chandru Ganeson, Bangalore (IN); Tensen Varghese, Bangalore (IN)

(73) Assignee: Akzo Nobel Coatings International B.V., Armhem (NL)

(21) Appl. No.: 13/263,642

(22) PCT Filed: Apr. 15, 2010
(86) PCT No.: PCT/EP2010/054942

§ 371 Date: Dec. 27, 2011

(30) Foreign Application Priority Data
Apr. 15, 2009 (GB) 0906448.6

(51) Int. Cl. B05C 1/06; A46B 11/00

(52) U.S. Cl. 401/25; 401/189

(57) ABSTRACT

A decking coating composition applicator (10) including a receptacle (16) which can receive a paint container (12) containing a coating composition, the receptacle including an air vent (28) and a liquid aperture (30) arranged such that they both penetrate a valve (66) on the paint container when the paint container is in the receptacle, thereby immersing both the air vent and the liquid aperture in the coating composition in the paint container and an applicator surface (18) fluidly connected to the receptacle such that the coating composition can be supplied to the applicator surface, the applicator surface comprising a pad portion (82), and a bristles portion (88), in which the bristles portion is positioned outside of an area defined by the pad portion.

The present invention relates to a coating composition applicator, in particular to a decking coating composition applicator.

Traditionally, coating compositions, such as stains, varnishes, or preservers, have been applied to wooden surfaces using a brush.

A particular application of wooden surfaces is for the construction of external decking. External decking surface areas are often large, and therefore traditional brush application is very time consuming. More recently, coating composition is applied to decking surfaces using a roller or pad. Both pad and roller application offer a quicker solution than brush application, but are limited in terms of giving an even distribution of the coating, particularly between the individual wooden boards which form the decking area.

U.S. Pat. No. 7,192,210 addresses this problem by providing an applicator including a pad, and bristles extending from the pad surface, the bristles serving to apply the coating between adjacent wooden boards.

Recent advances in decking style have resulted in the wooden decking boards including grooves to provide a more slip resistance surface, and to allow some drainage of water. This creates further problems in terms of applying a coating evenly to the surface.

According to the present invention there is provided a decking coating composition applicator including a receptacle for holding a coating composition, the applicator being fluidly connected to the receptacle such that the coating composition can be supplied to the applicator, and an applicator surface, the applicator surface comprising a pad portion, and a bristles portion, in which the bristles portion is positioned outside of an area defined by the pad portion.

Advantageously this enables coating composition fed to the pad portion to be evenly distributed onto a decking surface by the pad portion without disruption from the bristles portion, and then the bristles portion can assist in evenly distributing the coating composition onto the decking surface.

Another problem with known decking coating composition applicator is that the coating composition needs to be decanted from a paint container into the receptacle from where it is fed to the applicator surface which is time consuming.

According to another aspect of the present invention there is provided a decking coating composition applicator including a receptacle, and an applicator surface, the receptacle being fluidly connected to the applicator surface, in which the receptacle can receive a paint container containing a coating composition, such that the coating composition can be supplied to the applicator surface.

Advantageously this eliminates the requirement to decant paint from the paint container into the receptacle.

According to another aspect of the present invention there is provided a decking coating composition applicator including a receptacle which can receive a paint container containing a coating composition, the receptacle including an air vent and a liquid aperture arranged such that they both penetrate a valve on the paint container when the paint container is in the receptacle, thereby immersing both the air vent and the liquid aperture in the coating composition in the paint container.

When coating composition is supplied to the applicator surface, air is drawn into the paint container via the air vent. The fact that the air vent is immersed in the coating composition maintains turbulent liquid flow around the air vent and therefore reduces the risk of blocking the air vent.

According to another aspect of the present invention there is provided a decking coating composition applicator including a receptacle for holding a coating composition, and an applicator surface fluidly connected to the receptacle such that the coating composition can be supplied to the applicator surface, the applicator surface comprising a pad portion, and a bristles portion, in which the bristles portion has a width between 60% and 110% of the width of the pad portion, preferably between 70% and 90%.

The invention will now be described by way of example with reference to the accompanying drawings, in which:

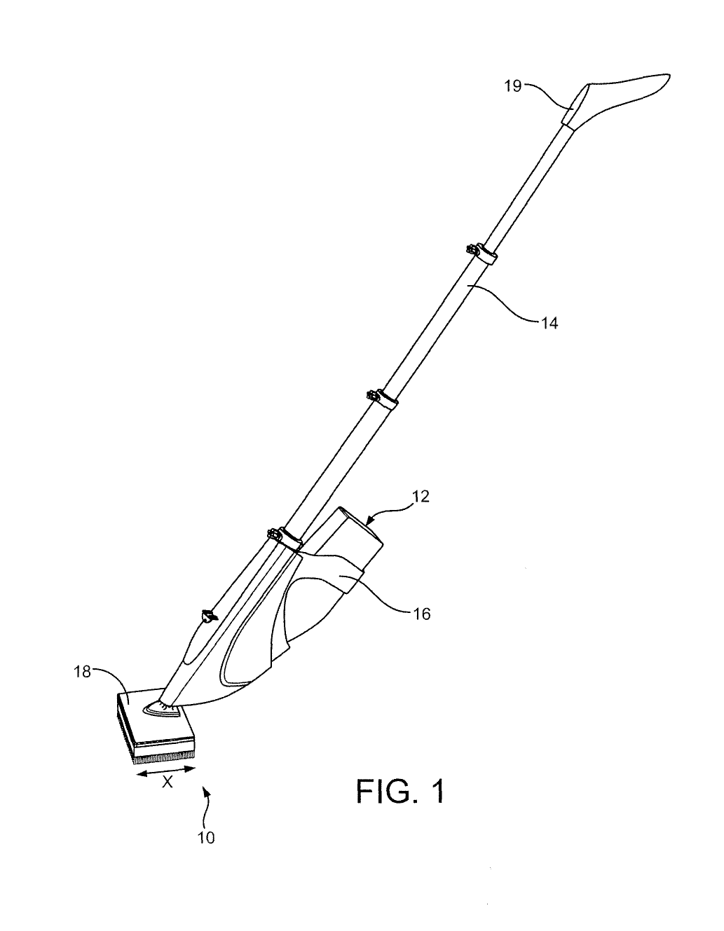

FIG. 1 is a perspective view of a decking coating composition applicator according to the present invention,

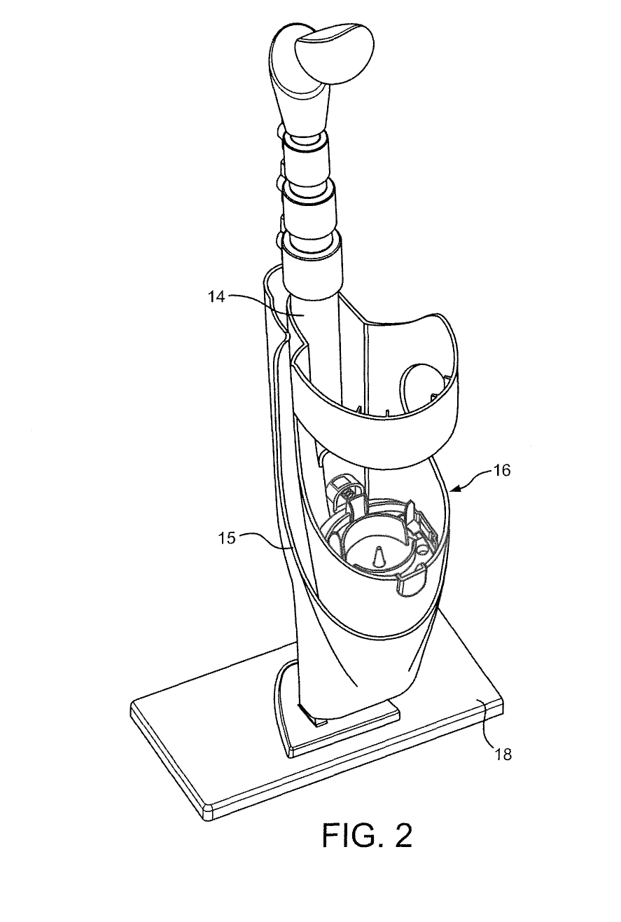

FIGS. 2 to 7 are perspective views of part of the applicator of FIG. 1,

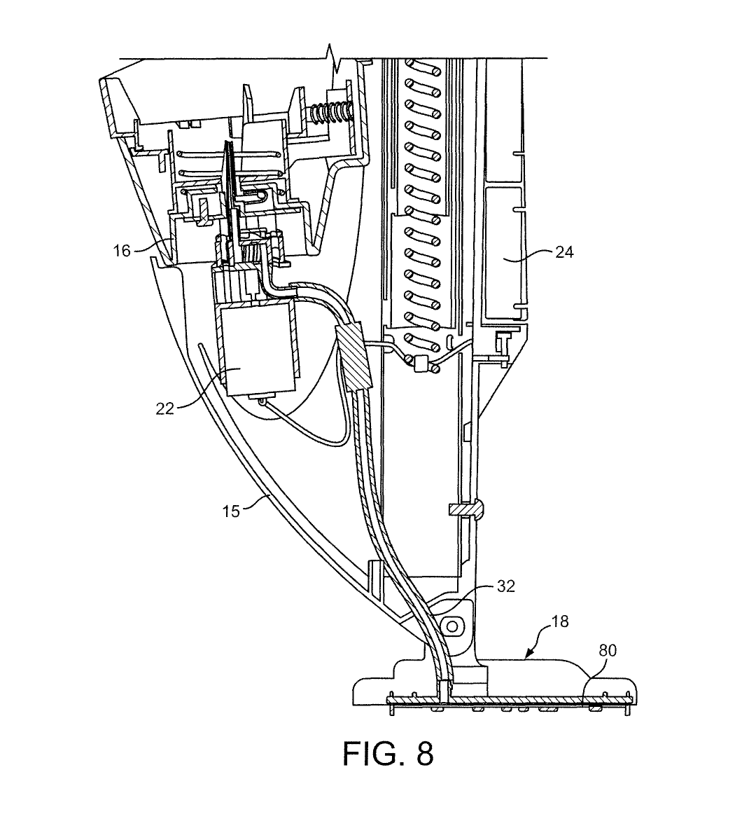

FIG. 8 is a side sectional view part of the applicator of FIG. 1,

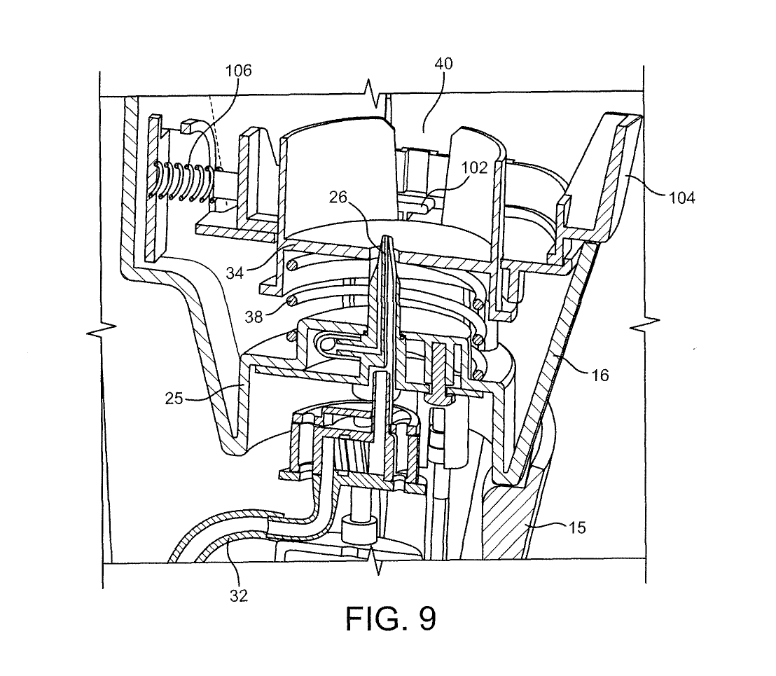

FIG. 9 is a side perspective sectional view part of the applicator of FIG. 1,

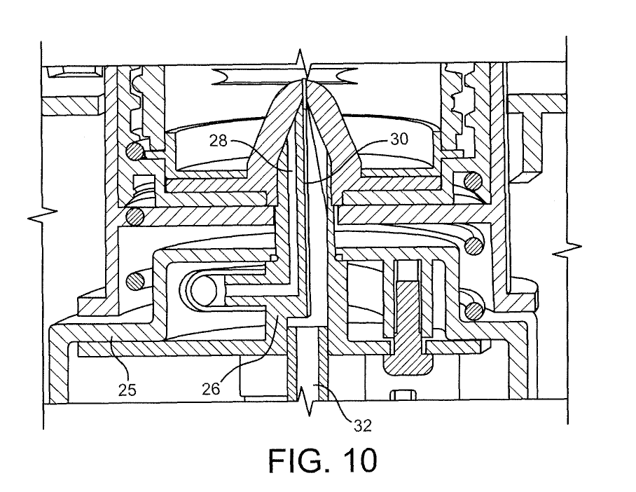

FIG. 10 is a side sectional view of part of the applicator of FIG. 1,

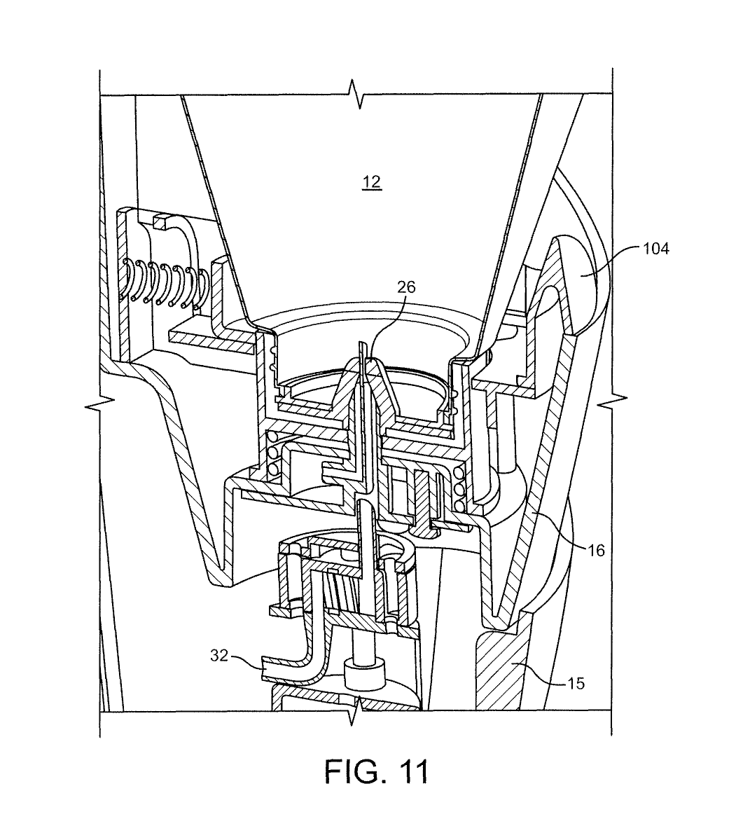

FIG. 11 is a side perspective sectional view part of the applicator of FIG. 1,

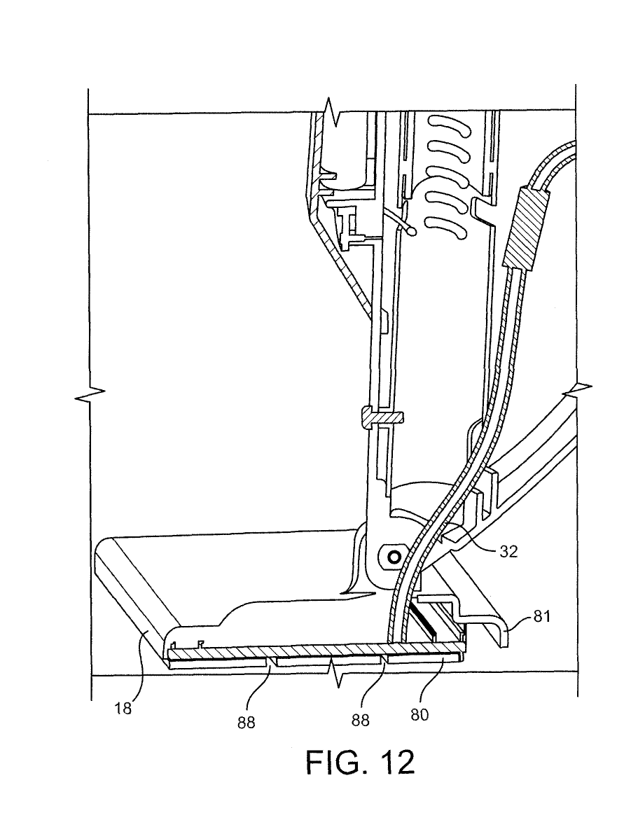

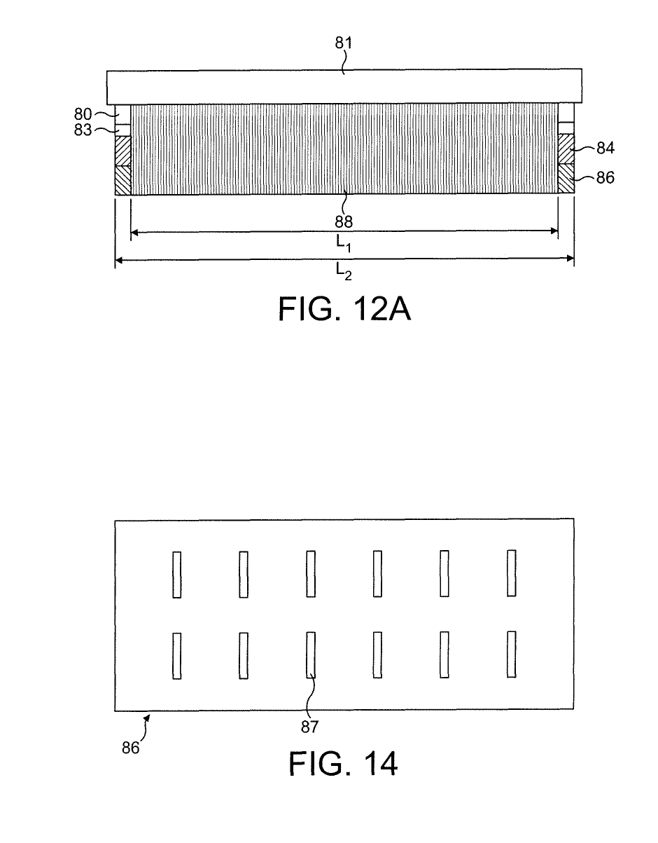

FIG. 12 is a side sectional view of part of the applicator of FIG. 1,

FIG. 12A is a front view of the applicator head of the applicator of FIG. 1,

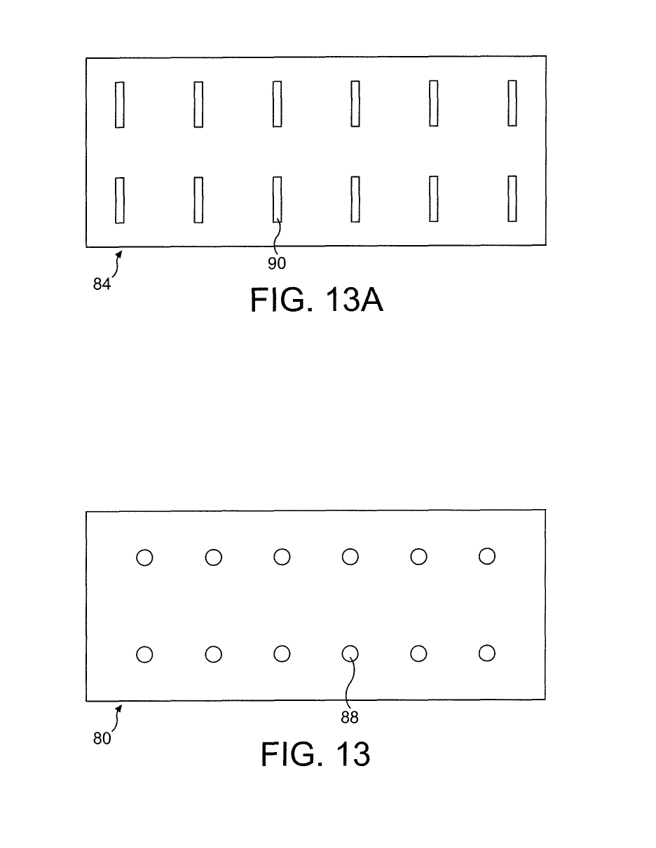

FIGS. 13 to 15 are plan views of part of the applicator head of FIG. 12A,

FIG. 16 is a rear view of the applicator head of FIG. 12A,

FIG. 17 is a side view of the applicator head of FIG. 12A,

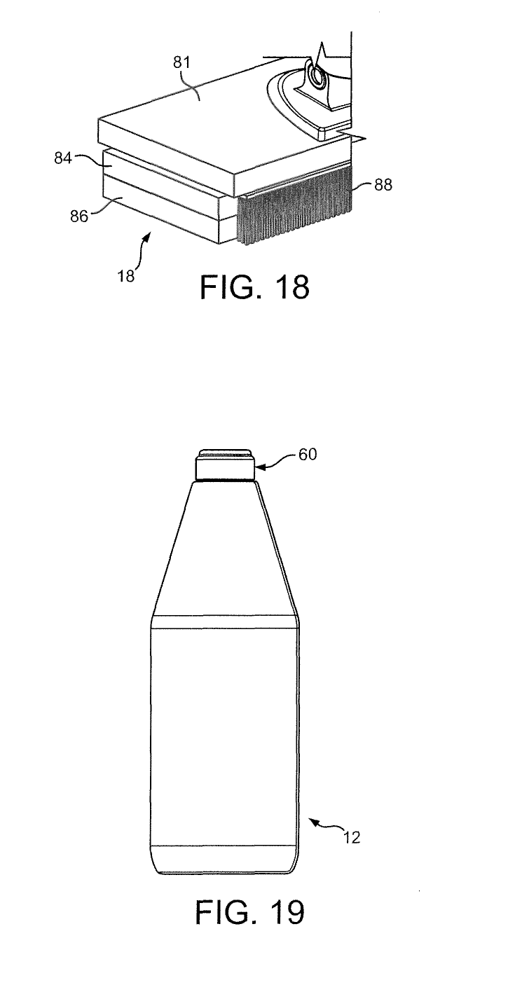

FIG. 18 is a perspective view of part of the applicator head of FIG. 12A,

FIG. 19 is a front view of a paint container for use with the applicator of FIG. 1,

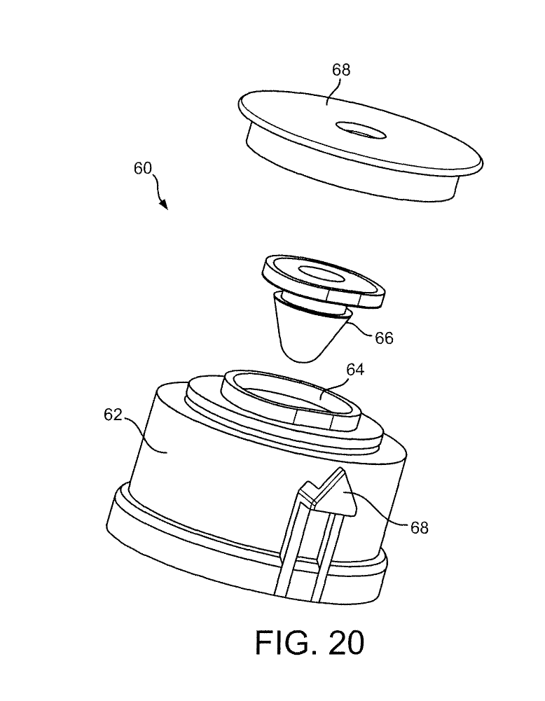

FIG. 20 is a perspective view of part of the paint container of FIG. 19,

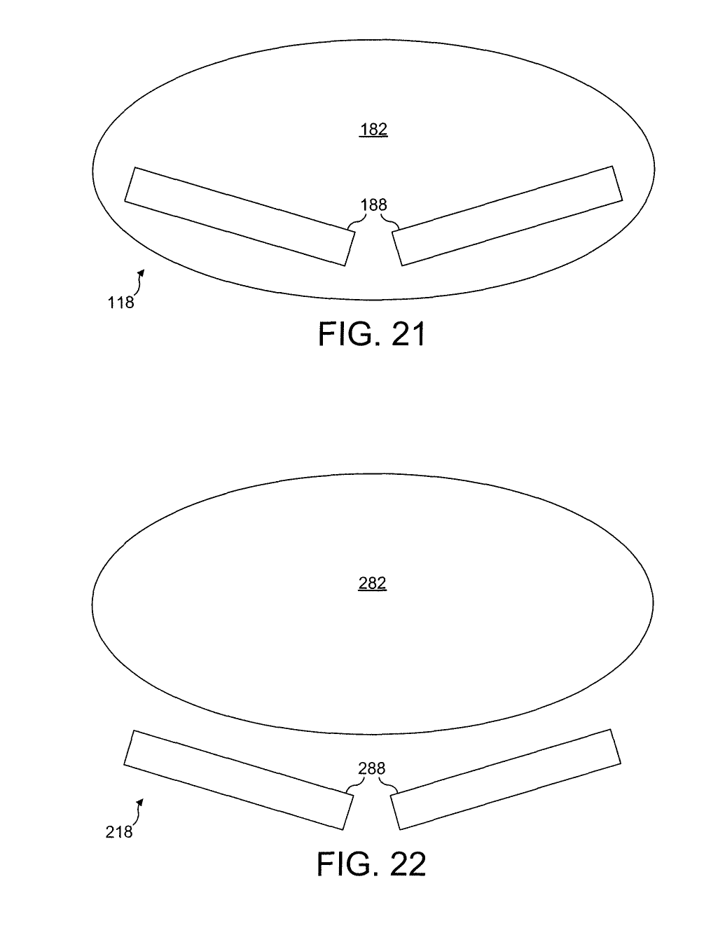

FIGS. 21 to 25 are plan views of alternative applicator heads,

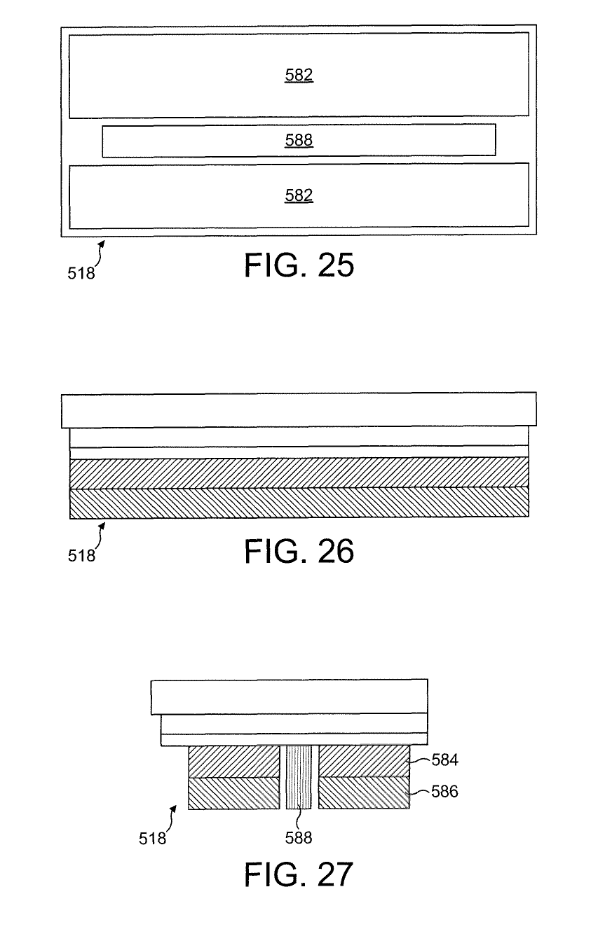

FIG. 26 is a rear view of the applicator head of FIG. 25,

FIG. 27 is a side view of the applicator head of FIG. 25,

FIG. 28 is a front view of the applicator of the present invention in use,

FIG. 29 is a front view of the applicator of the prior art in use.

FIG. 30 is a front view of part of the applicator head of the applicator of FIG. 1,

FIG. 31 is a side view of part of the applicator head of the applicator of FIG. 1,

FIGS. 32 and 33 are side views of part of the applicator head of the applicator of FIG. 1, and

FIGS. 34 and 35 are side views of part of the applicator head of the applicator of FIG. 1.

With reference to FIG. 1 there is shown a decking coating composition applicator 10 and a paint container 12. The paint container 12 includes a water or solvent based coating composition suitable for application to a horizontal decking surface, such as a stain, preserver, or varnish.

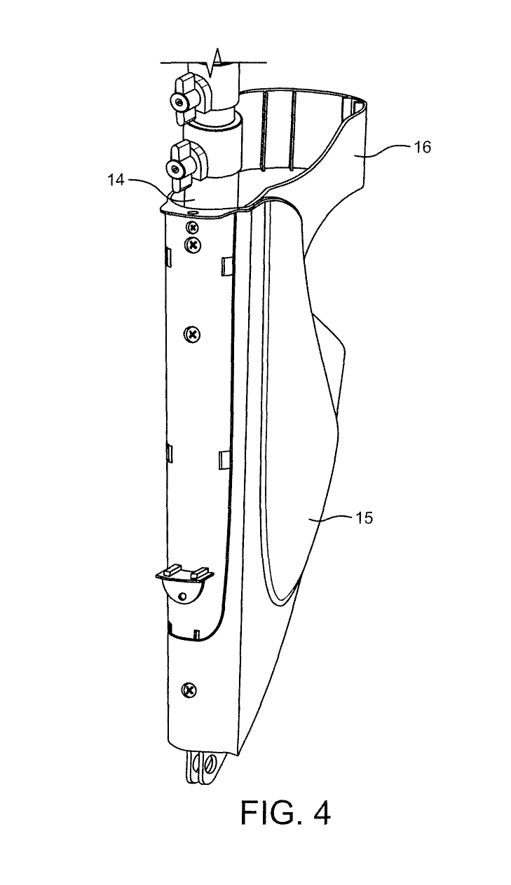

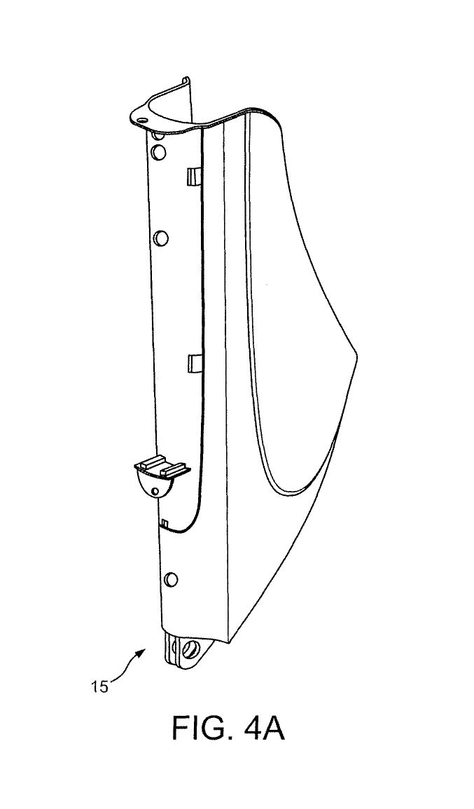

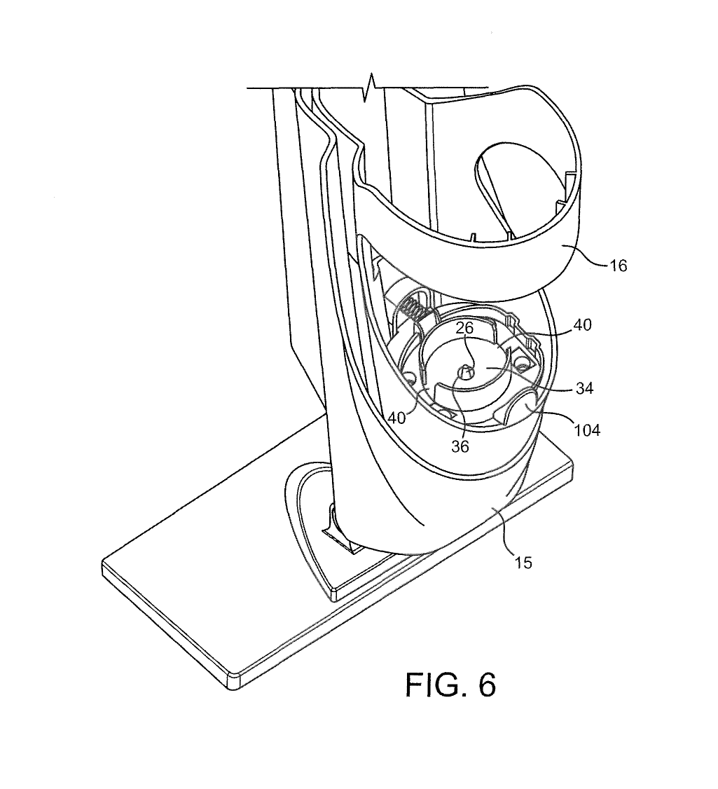

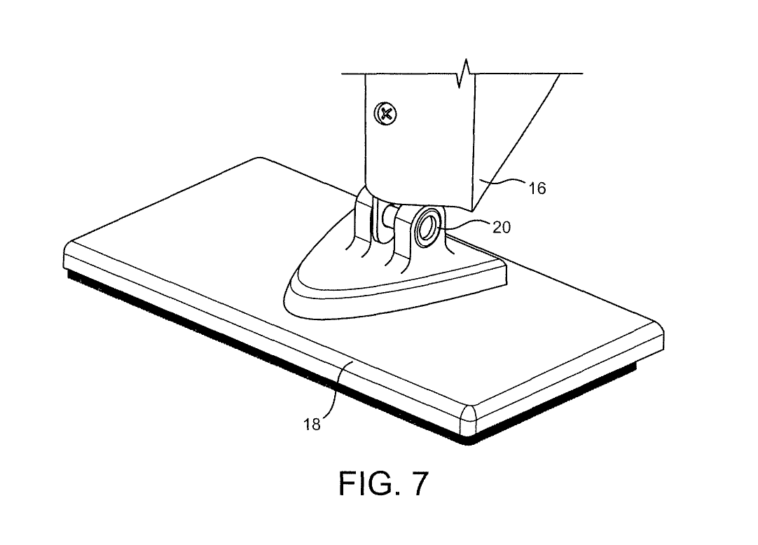

The applicator 10 comprises a metallic handle 14, a plastic main casing 15 (FIG. 4A), and a plastic applicator head 18 (FIG. 7).

A receptacle 16 locates inside and rests upon the main casing 15 (FIGS. 2, 4 and 9).

The handle 14 includes a switch 19 which is electrically connected to a pump 22, the pump being powered by a battery pack 24. The pump 22 and the battery back 24 are housed within the main casing 15.

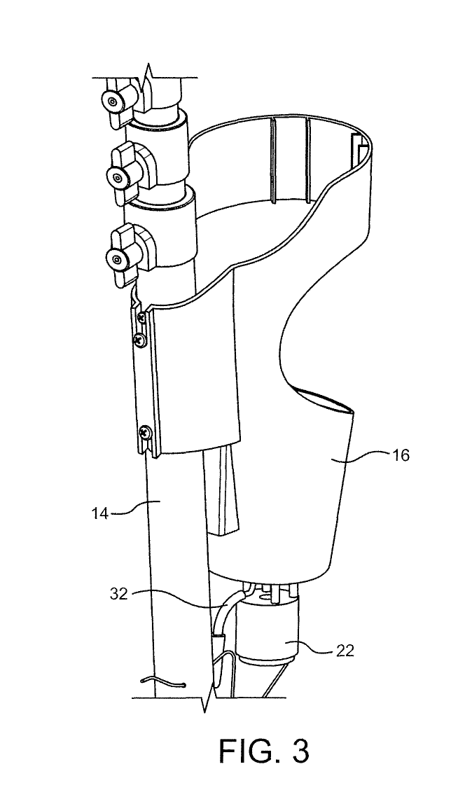

The receptacle 16 is a plastic moulding which is secured to the handle 14 in a known way (FIG. 3).

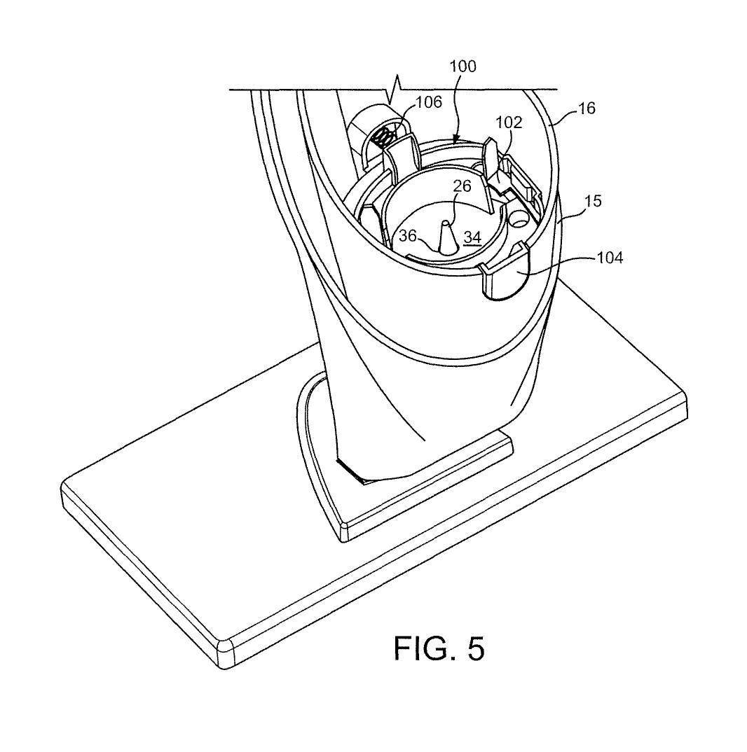

In FIGS. 5 and 6, the receptacle 16 has a base 25 from which a protrusion in the form of a spike 26 projects upwardly. The spike 26 includes an air vent 28, and a liquid aperture 30 (best seen in FIG. 10). The liquid aperture 30 is fluidly connected to the applicator head 18 via a flexible conduit 32 (FIGS. 8 and 9).

In FIGS. 5 and 6, a thrust plate 34 is housed within the receptacle 16, and includes an aperture 36 through which the spike 26 projects. A spring 38 is positioned between the underside of the thrust plate 34 and the base 25 of the receptacle 16 such that the thrust plate 34 is biased upwardly.

In FIG. 9, the receptacle 16 includes a sliding release mechanism 100 which includes a snap-projection 102, and a release button 104. The sliding release mechanism 100 is biased by spring 106 to a position where snap-projection 102 engages with guide projection 68 on the paint container 12 to retain the paint container in the receptacle 16, until release by pressing release button 104 which acts against the spring 104 to disengage the snap-projection 102 from the guide projection 68.

The thrust plate 34 includes guide slots 40 to guide the paint container 12 when it is inserted into the receptacle 16 (see below).

The applicator head 18 is pivotally attached to the receptacle via pin 20 (FIG. 7).

With reference to FIGS. 12 to 18, the applicator head 18 includes a substantially rectangular housing 81 onto which is fixed a distribution plate 80, and a pad portion 82 comprising a backing plate 83, a foam layer 84, and a flock layer 86. The backing plate 83 includes securing means, for example, Velcro™ (not shown), to fix the pad portion 82 to the distribution plate 80 which has corresponding securing means (also not shown).

The pad portion has a width L₂.

Typically the foam layer has a thickness of 8 mm, and the flock layer a thickness of 15 mm.

A bristles portion 88 is secured to the plastic housing 81. The bristles that make up the bristles portion are those typically used in paint brushes used to apply coating compositions to wood surfaces, and have a bristle length in the order of 25-30 mm such that the flock layer 84 and bristles portion 88 have substantially the same lowest point.

The bristles portion has a width L₁.

In FIGS. 30 and 31, the bristles portion 88 comprises a plurality of individual bristles 200 with an upper end 210 and a lower tip 212. The upper ends 210 of the bristles 200 are secured to a bar 214. The bar 214 is secured to the plastic housing 81.

Typically the width of the bristles portion is between 100 to 150 mm, and between 60% and 110% of the width of the pad portion. The width of the bristles portion will also be wider than the gap between decking boards 200, so that in use the bristles portion 88 and the flock layer 84 are both in contact with the upper surface 210 of the decking boards (FIG. 28). This contrasts with prior art devices where the bristles portion 88′ has a width smaller than the gap G between decking boards so that the bristles portion and the pad portion are not both in contact with the upper surface 210 of the decking boards (FIG. 29).

The distribution plate 80 includes a plurality of through apertures 88 which are fed with coating composition via the flexible conduit 32 (FIGS. 12 and 13).

The foam layer 84 includes a plurality of through slots 90 which coincide with the through apertures 88 on the distribution plate 80 (FIG. 13A)

The flock layer 86 also includes a plurality of through slots 87 which are substantially identical to, and coincide with the slots 90 on the foam layer 84 (FIG. 14).

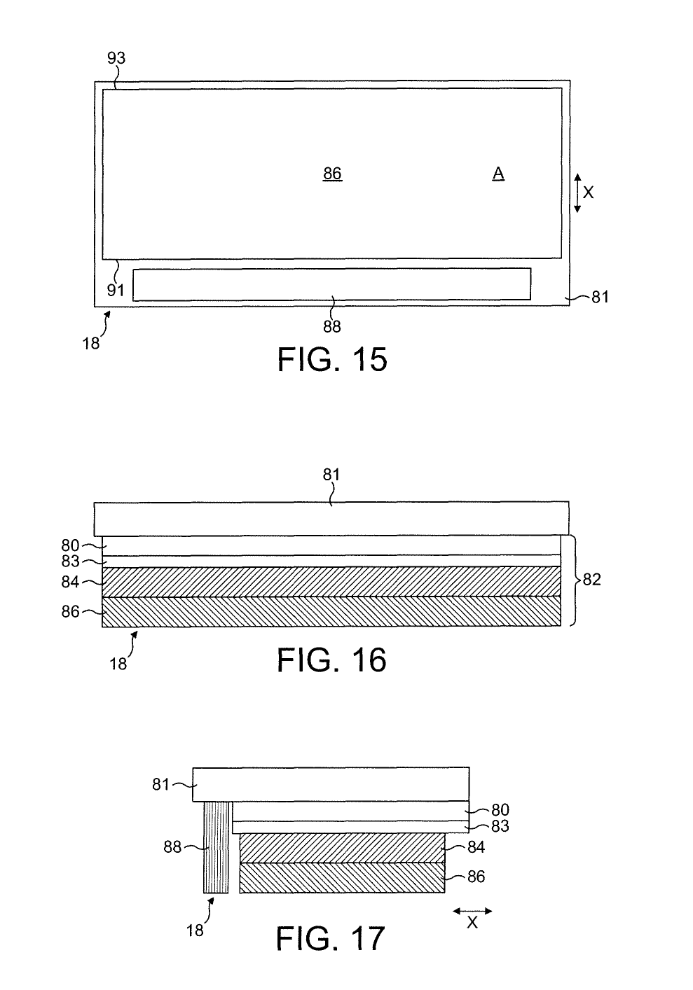

It can be seen from FIGS. 15 and 17 that the pad portion defines an area A, and that the bristles portion 88 is positioned outside of this area. It can also be seen that the bristles portion 88 is spaced from the pad portion 83.

The pad portion 82 (comprising the foam and flock layers) has a front 91 and rear 93 straight edge, and it can be seen that the bristles portion 88 is substantially parallel to both edges 91,93 (FIG. 15).

In FIGS. 19 and 20, the paint container 12 includes a closure assembly 60 comprising a closure 62 with an aperture 64 into which is located silicon valve 66. An overcap 68 fits onto the closure 62 to protect the silicon valve 66 when the paint container 12 is not positioned in the receptacle 16. The closure 62 further includes two guide projections 68 positioned radially opposite each other (only one shown in Figure ?).

The paint container 12 is inserted into the receptacle 16 of the applicator 10 as follows, the progression of which is shown in FIGS. 9 to 11:

Firstly, the overcap 68 is removed from the closure 60. The paint container 12 is positioned upside down and inserted into the receptacle 16 such that guide projections 68 on the closure 62 locate inside slots 40 on the thrust plate 34. The guide projections 68 then engage with snap-projection 102 to secure the paint container 12 in the receptacle 16.

At the same time, the thrust plate 34 is pushed downwards such that spike 26 penetrates the silicon valve 66.

Once the silicon valve 66 is penetrated, a fluid connection is made between the coating composition in the paint container 12, and apertures 88 on the distribution plate 80, via liquid aperture 30 and flexible conduit 32 (FIG. 11)

Activation of switch 19 on the handle 14 causes the pump 22 to operate, and the coating composition is supplied to the distribution plate apertures 88. The coating composition then passes through the slots in the foam and flock layers, at which point the applicator 10 is ready to apply coating composition to a decking surface during a paint mode. As the coating composition is drawn from the paint container, the air vent 28 ensures that the paint container does not collapse.

In FIGS. 1, 15 and 17, the applicator is moved in the direction of arrow X to apply the coating composition. It will be appreciated that the bristles portion 88 is substantially perpendicular to this direction which ensures an even spread of coating composition.

Since the bristles 200 are fixed to the bar 214 at the upper ends 210, the bristles are able to pivot from a position where all of the lower tips are in position 212 (FIGS. 32 and 34), to a position where some of the tips are in position 212′ (FIGS. 33 and 35).

In FIGS. 32 and 34, the applicator is sitting on part of a grooved decking board 300. The decking board 300 has an exposed surface comprising an upper surface 312 and a lower surface 310. When coating composition is applied to the decking board, the user will push the applicator in the direction of arrow X, and at the same time apply a downwards force (direction of arrow F) which will compress the flock layer 86 from the position of FIGS. 32 and 35 to the position of FIGS. 33 and 35.

When the flock layer is compressed, the bristles 200 are able to pivot when the applicator moves in the direction of arrow X such that the lower tips 212 remain in contact with the upper surface 312 and the lower tips 212′ remain in contact with the lower surface 310 of the decking board 300. Thus, the coating composition is applied evenly to all of the exposed surface due to a combination of the bristles 200 being able to pivot and follow the profile of the decking, and the flock layer which remains in contact with the upper surface 312.

Comparing FIGS. 34 and 35, it can be seen that the lower tips 212, 212′ of the bristles 200 can pivot and therefore move vertically relative to each other to follow the profile of the decking boards, i.e. the bristles can pivot and move vertically independently.

When the user has finished applying the coating composition, the switch 19 is released, and the flow of coating composition stops. The paint container can then be released from the receptacle 16 by depressing button 104 which disengages projection 102 from the guide projection 68 enabling removal of the paint container.

The receptacle can then be filled with a cleaning fluid such as water, followed by activation of the pump again to feed water to the pad portion in a cleaning mode. This serves to clean the conduit 32 and the liquid aperture 30 such that little or no coating composition remains. The pad portion can then be removed from the distribution plate and cleaned as required.

In an alternative embodiment, the receptacle can include a closure which fits onto the receptacle to form a seal during the cleaning mode such that a vacuum is formed as water is expelled from the receptacle to the applicator), thereby causing the air vent to draw in air which in turn prevents the air vent from blocking.

FIGS. 21 to 27 show alternative pad portion and bristles portion combinations.

In FIG. 21, the applicator head 118 includes an oval pad portion 182 with two identical bristles portions 188 which are linear, arranged within the area defined by the pad portion, but not parallel to the movement of the applicator in direction X.

The embodiment of FIG. 22 is identical to the embodiment of FIG. 21 except the bristles portions 288 are arranged outside the area defined by the pad portion 282.

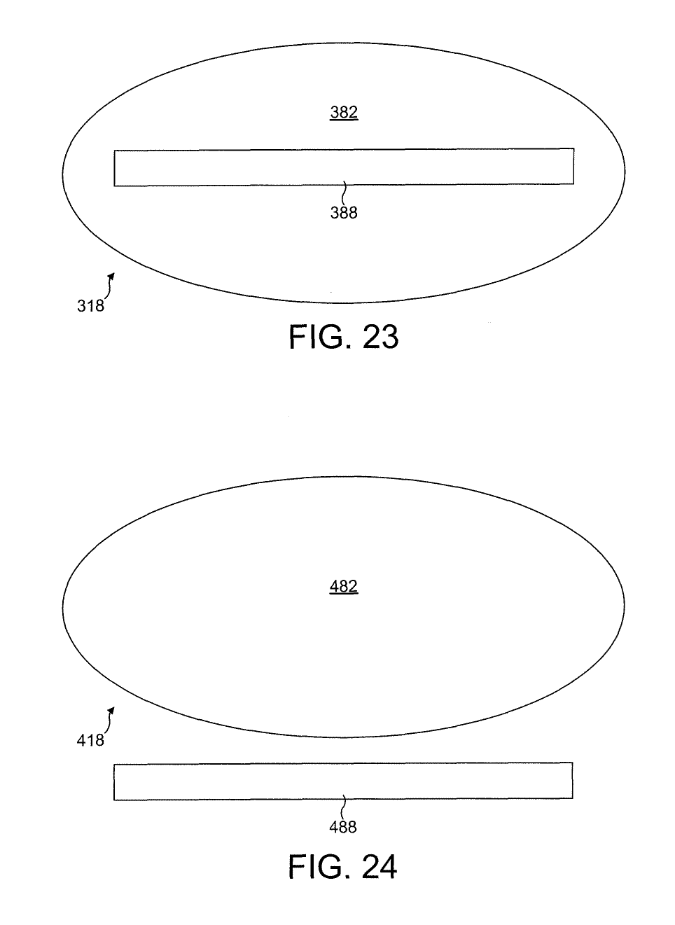

The embodiment of FIG. 23 is identical to the embodiment of FIG. 21 except the bristles portion 388 is arranged parallel to the movement of the applicator in direction X.

The embodiment of FIG. 24 is identical to the embodiment of FIG. 23 except the bristles portion 488 is arranged outside the area defined by the pad portion 482.

In FIGS. 25 to 27 the applicator head 518 is identical the embodiment of FIGS. 1 to 20 except the bristles portion 588 is arranged within the area defined by the pad portion, and the pad portion comprises two identical pad portions 582 positioned either side of the bristles portion 588.

Whilst the embodiments above relate to decking, it will be appreciated that the concepts of the invention can be used on other wooden surfaces both internally and externally.

The embodiments above also relate to using a pump. It will be appreciated that since the paint container is positioned with its open end facing downwards, it is also possible to rely on a gravity feed to supply the coating composition to the pad portion instead of a pump.

It will also be appreciated that for the embodiments using a pump, the use may not be limited to horizontal surfaces.

1. A decking coating composition applicator including a receptacle for holding a coating composition, and an applicator surface fluidly connected to the receptacle such that the coating composition can be supplied to the applicator surface, the applicator surface comprising a pad portion, and a bristles portion, wherein the bristles portion is positioned outside of an area defined by the pad portion.

2. The decking coating composition applicator according to claim 1 wherein the bristles portion is arranged to be substantially perpendicular to the direction of travel of the applicator in use.

3. The decking coating composition applicator according to claim 1 wherein the bristles portion is spaced from the pad portion.

4. The decking coating composition applicator according to claim 1, wherein the pad portion includes at least one straight edge, and wherein the bristle portion is substantially parallel to the at least one straight edge.

5. The decking coating composition applicator according to claim 4 wherein the at least one straight edge is a front edge.

6. The decking coating composition applicator according to claim 1, wherein the bristles portion has a width which is between 60% and 110% of the width of the pad portion.

7. The decking coating composition applicator according to claim 1, wherein the pad portion is substantially rectangular with a straight front or rear edge, and wherein the bristle portion is substantially parallel to the front or rear edge.

8. The decking coating composition applicator according to claim 1, wherein the pad portion comprises an upper foam layer, and a lower flock layer.

9. The decking coating composition applicator according to claim 8 wherein the upper foam layer includes a plurality of through apertures to allow the coating composition to pass therethrough.

10. The decking coating composition applicator according to claim 9 wherein the lower flock layer includes a plurality of through apertures to allow the coating composition to pass therethrough.

11. The decking coating composition applicator according to claim 10 wherein the through apertures of the foam layer and the flock layer coincide.

12. The decking coating composition applicator according to claim 11, wherein the through apertures are slots arranged such that they are substantially parallel to the direction of travel of the applicator in use.

13. A decking coating composition applicator including a receptacle which can receive a paint container containing a coating composition, the receptacle including an air vent and a liquid aperture arranged such that they both penetrate a valve on the paint container when the paint container is in the receptacle, thereby immersing both the air vent and the liquid aperture in the coating composition in the paint container.

14. The decking coating composition applicator according to claim 13 wherein the air vent and the liquid aperture are arranged on a single protrusion which penetrates the valve on the paint container.

15. A decking coating composition applicator including a receptacle, and an applicator surface, the receptacle being fluidly connected to the applicator surface, wherein the receptacle is configured to receive a paint container containing a coating composition, such that, in a coating mode, the coating composition can be supplied to the applicator surface.

16. The decking coating composition applicator according to claim 15, wherein the receptacle is also configured to hold a cleaning fluid such that, in a cleaning mode, the cleaning fluid can be supplied to the applicator surface.

17. The decking coating composition applicator according to claim 16, wherein the receptacle includes a cover which forms a seal on the receptacle such that a vacuum is formed in the receptacle when water is being supplied to the applicator surface during the cleaning mode.

18. The decking coating composition applicator according to claim 13, further including a pump which supplies coating composition from the paint container to the applicator surface.

19. A decking coating composition applicator including a receptacle for holding a coating composition, and an applicator surface fluidly connected to the receptacle such that the coating composition can be supplied to the applicator surface, the applicator surface comprising a pad portion, and a bristles portion, wherein the bristles portion has a width between 60% and 110% of the width of the pad portion.

20. The decking coating composition applicator according to claim 19 wherein the bristles portion is arranged to be substantially perpendicular to the direction of travel of the applicator in use.

21. The decking coating composition applicator according to claim 19 wherein the bristles portion is substantially linear.

22. The decking coating composition applicator according to claim 19, wherein the bristles portion is positioned outside of an area defined by the pad portion.

23. A decking coating composition applicator including a receptacle for holding a coating composition, and an applicator surface fluidly connected to the receptacle such that the coating composition can be supplied to the applicator surface, the applicator surface comprising a pad portion, and a bristles portion, wherein the bristles portion comprises a plurality of bristles with a lower tip, the bristles being able to independently pivot as the applicator moves such that the lower tips move vertically to remain in contact with the surface profile of an associated decking board.

24. The decking coating composition applicator according to claim 23 wherein the pad portion is compressible.

25. The decking coating composition applicator according to claim 23 wherein the bristles portion has a width which is between 60% and 110% of the width of the pad portion.

26. The decking coating composition applicator according to claim 24, wherein the lower tips of the bristles and the lowest point of the pad portion are substantially at the same vertical level when the pad portion is uncompressed.
